(19) United States
(12) Patent Application Publication
(10) Pub. No.: US 2018/0207497 A1
(43) Pub. Date: Jul. 26, 2018

(54) SAND TRAP RAKE SYSTEM

(71) Applicant: Debra Abshire, Richmond, TX (US)

(72) Inventor: Debra Abshire, Richmond, TX (US)

(21) Appl. No.: 15/412,299

(22) Filed: Jan. 23, 2017

(51) Int. Cl. A63B 57/50; A01D 7/02; B60R 11/06; B60Q 9/00; H04B 7/24

(52) U.S. Cl. CPC A63B 57/50; A01D 7/02; H04B 7/24; B60Q 9/00; B60R 11/06

(57) ABSTRACT

A sand trap rake system for golf cart that includes: a rake with a transmitter in the rake and a receiver in a rake bracket on a golf cart, where the rake bracket is adapted to store the rake. A RF signal transmits between the transmitter and the receiver with an alert on the golf cart, where the alert emits an signal upon when the RF signal strength diminishes to a predetermine strength. The RF signal strength accordingly correlates to a distance between the transmitter and the receiver. Preferably, the rake head is foldable and the rake bracket includes a rake receptacle to store the rake.

### BACKGROUND OF THE INVENTION

### Field of Invention

The present invention relates to a sand trap rake system for implementation onto a golf cart.

### Description of Related Art

Many golfers enjoy golf on a recreational basis on many courses around the world. As is well known, golf courses involve landscape dedicated to the game of golf. Typically golf courses include a tee box, fairway, and the greens surrounding the hole. Throughout a golf course along the fairway and the surrounding greens sand traps are placed as obstacles raising the difficulty of the golf course. Other hazards may include trees, rough, and water hazards. All these must be avoided to minimize stroke usage, however many times golfers land in a sand trap and must strike their ball from the sand trap to continue play. As common golf courtesy, golfers should rake the sand trap after entering to take their shot to leave a smooth surface for other golfers. Some golf courses leave rakes near each sand trap. Others provide rakes with the golf cart. In cases where a rake is provided with a golf cart, golfers may accidently leave the rake somewhere on the golf course after use. As a result, it would be advantageous to have a system in place to maintain rakes with golf carts as originally intended.

### SUMMARY OF THE INVENTION

The present invention relates to a sand trap rake system for golf cart that includes: a rake with a transmitter in the rake and a receiver in a rake bracket on a golf cart, where the rake bracket is adapted to store the rake. A RF signal transmits between the transmitter and the receiver with an alert on the golf cart, where the alert emits an signal upon when the RF signal strength diminishes to a predetermine strength. The RF signal strength accordingly correlates to a distance between the transmitter and the receiver. Preferably, the rake head is foldable and the rake bracket includes a rake receptacle to store the rake.

### BRIEF DESCRIPTION OF DRAWINGS

FIG. 1 depicts a rake system for use on a golf cart.

### DETAILED DESCRIPTION

The present invention relates to a rake system for use on a golf cart, where the rake includes a transmitter coupled with a receiver on the golf cart. The transmitter and receiver help to maintain the location of the rake and in particular helps the golfer to avoid leaving the rake on the golf course during use thereof. A alert in the form of an audible alarm or visual light is activated, if a golfer leaves the rake away from the golf cart at a predetermined distance. This system enables the assistant to alert the golfer to retrieve the rake before moving on to the next shot on the golf course.

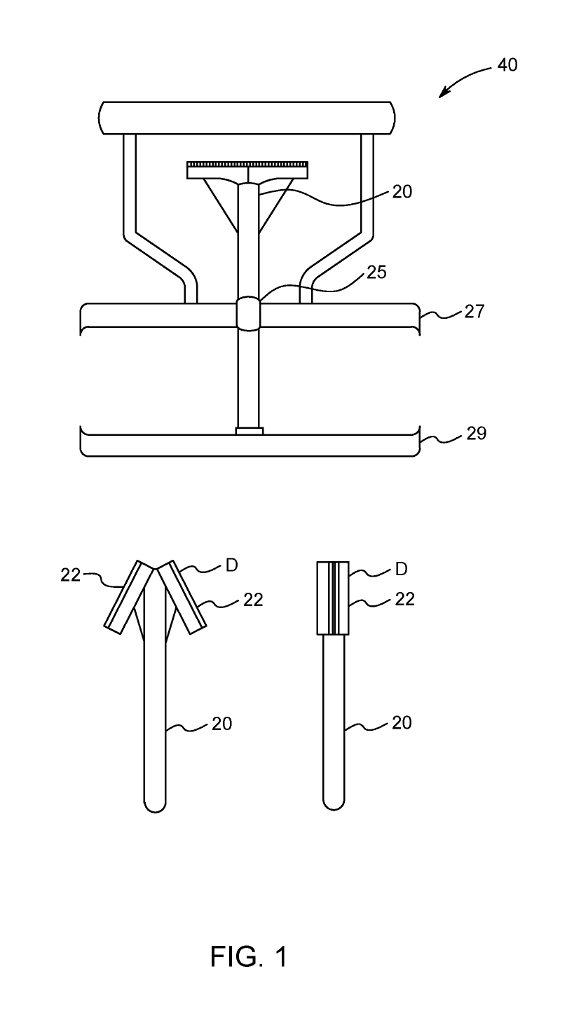

In reference FIG. 1, a Sand Trap Rake System 40 in accordance with the present invention is depicted. This rake System 40 includes Rake 20 as shown in FIG. 1 which is mounted onto a Bracket 27. The Bracket 27 includes a Receptacle 25 that receives Rake 20 during normal use. This rake bracket system may be placed upon the rear of a golf cart and further includes a lower Bracket 29. Once mounted this provides a conventional storage location for a rake.

Rake 20 in this particular invention includes a transmitter, which transmits a RF signal to a receiver placed in the golf cart. This receiver is coupled with a alerting device such as an audible alarm or a visual light which alerts the golfer of a missing rake from the Bracket 27. The system sets up a pre-determined range based upon the signal strength between the transmitter and a receiver. Once the signal diminishes to a pre-determined level the alert sounds therefore alerting the golfer that the rake has been left out of place or left on the golf course. This system allows the golfer to easily retrieve the rake and place it back into the bracket system depicted in FIG. 1.

Other features of this Rake 20 includes a Foldable Head 22 also shown in FIG. 1. The Head 22 may be folded as shown and then placed in a closed position. The rake may conveniently toggle between these two positions to provide a more compact storage unit. As a result, the RF signal correlates with the distance between the transmitter and receiver used in the system. The alerting signal may be set at a reasonable distance to ensure that the golfer may quickly retrieve the rake before leaving it behind.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A sand trap rake system for golf cart comprising:
a. a rake;
b. a rake head on the rake;
c. a transmitter in the rake;
d. a receiver in a rake bracket on a golf cart, where the rake bracket is adapted to store the rake;
e. a RF signal transmitted between the transmitter and the receiver; and
f. an alert on the golf cart, where the alert emits an signal upon when the RF signal strength diminishes to a predetermine strength and said RF signal strength correlates to a distance between the transmitter and the receiver.

2. The sand trap rake system according to claim 1, where the rake head is foldable.

3. The sand trap rake system according to claim 1, where the rake bracket includes a rake receptacle.

4. The sand trap rake system according to claim 1, where the rake bracket includes an upper bracket and a lower bracket.
